(19) United States
(12) Patent Application Publication
(10) Pub. No.: US 2026/0262650 A1
(43) Pub. Date: Sep. 10, 2026

(54) TRANSPARENT BORDEAUX MIXTURE NANO-SUSPENSION DISPERSION

(71) Applicant: Ziyong ZHANG, Nanjing (CN)

(72) Inventors: Ziyong ZHANG, Nanjing (CN); Bing LIANG, Nanjing (CN)

(73) Assignee: Ziyong ZHANG, Nanjing (CN)

(21) Appl. No.: 19/663,975

(22) Filed: Apr. 30, 2026

Related U.S. Application Data
(63) Continuation of application No. PCT/CN2024/129526, filed on Nov. 2, 2024.

(30) Foreign Application Priority Data
Nov. 2, 2023 (WO) PCT/CN2023/129390
May 15, 2024 (WO) PCT/CN2024/093409

(51) Int. Cl. A01N 59/20; A01N 25/04; A01P 1/00; A01P 3/00

(52) U.S. Cl. CPC A01N 59/20; A01N 25/04; A01P 1/00; A01P 3/00

(57) ABSTRACT

The present invention belongs to the field of nanopesticides, specifically relating to the preparation of suspension dispersions with a microparticle size of less than 100 nanometers for pesticide varieties that are insoluble in water and solvents. It is a nano-suspension dispersion in which basic copper sulfate microparticles are suspended and dispersed in a water-soluble polymeric dispersant existing in a random coil morphological structure in water.

### CROSS-REFERENCE TO RELATED APPLICATIONS

This application is the U.S. continuation application of International Application No. PCT/CN2024/129526 filed on 2 Nov. 2024 which designated the U.S. and claims priority to Chinese Application No. PCT/CN2023/129390 and PCT/CN2024/093409 filed on 2 Nov. 2023 and 15 May 2024, respectively, the entire contents of each of which are hereby incorporated by reference.

### TECHNICAL FIELD

The present invention belongs to the field of nanopesticides, and particularly relates to the preparation of a suspension dispersion of water-insoluble and organic solvent-insoluble microparticles with a size of less than 100 nanometers.

### BACKGROUND TECHNOLOGY

Modern agricultural production must utilize pesticides. Improving the formulation performance of existing pesticide varieties, increasing efficacy, reducing pesticide usage, and mitigating environmental impact are of great significance for sustainable agricultural development.

An effective approach to achieving pesticide reduction is to significantly decrease the microparticle size of the active ingredients in pesticide formulations. For water-insoluble pesticides, reducing to the minimum size means a few nanometers. Nanopesticides refer to formulations where the pesticide microparticle size is on the nanoscale (1 to 100 nm). The microparticle size of traditional pesticide formulations is on the micrometer scale, ranging from a few micrometers to tens of micrometers or even larger. If the microparticle size is reduced to the nanoscale, shrinking by a factor of a thousand, theoretically, the number of microparticles can increase a billionfold, and the surface area can increase a thousandfold. The dramatic increase in the number and surface area of pesticide microparticles allows for more uniform dispersion on leaves and broader contact with targets, enabling the efficacy to be fully exerted and enhanced.

On Apr. 1, 2019, the International Union of Pure and Applied Chemistry (IUPAC), on the occasion of its 100th anniversary, announced the “Top Ten Chemical Innovations That Will Change the World,” with “nanopesticides” ranking first. The reason is that, based on the continuous growth of the world's population, it is predicted that the global population will approach 10 billion by 2050. To feed such a massive population, it is necessary to significantly increase agricultural yields while minimizing the environmental impact of land use, including reducing pesticide pollution and water usage. Nanopesticides, with their small microparticle sizes and better target absorption, will be an excellent tool to solve the main problems of traditional pesticides (environmental pollution, pesticide accumulation in organisms, and significant increases in pest and disease resistance). While it cannot be said to be the sole path for sustainable agricultural development, it is certain that its impact on the ecological environment and human health is much smaller, making the earth more sustainable.

Bordeaux mixture is a typical inorganic compound pesticide variety. Over a century since its creation, it has played a major role in preventing and controlling various plant fungal diseases. It contains no harmful impurities, is not prone to causing phytotoxicity, is resistant to rain wash, has no drug resistance, and can be compounded with certain other pesticides; it remains a widely used broad-spectrum protective fungicide today. The active ingredient in Bordeaux mixture is basic copper sulfate, but its solubility in water is extremely low, at only 1.06 mg/L, and additionally, one of the commonly used raw materials for its preparation is calcium hydroxide, which also has poor water solubility; what is obtained is a light blue, viscous suspension. For convenience of use, enterprises prepare it into solid basic copper sulfate and process it into formulations, mainly wettable powders, and a small amount of suspension concentrates. The microparticle sizes of these formulations are all above a dozen to tens of micrometers. Like other traditional pesticide formulations, the relatively large pesticide microparticle size restricts the improvement of the efficacy of Bordeaux mixture and also leads to a relatively large dosage per unit area.

Bordeaux mixture is an ancient and widely used agricultural fungicide, primarily made by mixing copper sulfate, slaked lime (calcium hydroxide), and water. This mixture is particularly effective in preventing and controlling fungal infections on plants such as grapevines, potatoes, peach trees, apple trees, and banana plants. Although Bordeaux mixture holds a certain importance in organic farming, its use has raised some concerns in the environment; the long-term, massive application of copper-containing formulations will inevitably impact and harm the ecological environment. Especially, the accumulation of its main component, copper, may lead to soil and water pollution, as well as potential toxicity to some organisms in the ecosystem, such as fish and earthworms.

High concentrations of copper are used for controlling plant fungal and bacterial diseases, and it is the only product capable of controlling downy mildew caused by yellow molds. At low concentrations, copper is also an essential micronutrient element for plants and animals. Most crops require copper as a micronutrient, and this usage amount is also substantial. For crops grown in acidic organic soils, the application concentrations are between 3.4 to 6.7 kg/hectare or 2.0 to 3.4 kg/hectare, respectively. For rapid effects, foliar spraying is also carried out at a Cu ion concentration of 8 g/L. Such continuous and massive use of copper formulations to control plant diseases and as a nutritional element will inevitably cause environmental pollution and affect the health of animals and plants. Developed countries around the world are currently making efforts to reduce the usage of copper-containing formulations. European Commission Regulation (EC) 889/2008 stipulates copper dosages for organic farming, recommending an application rate of 1 kg copper/hectare per treatment, with a maximum of 6 kg/hectare/year. Further actions are being taken to lower the maximum allowable copper concentration. A survey conducted in 12 European countries showed that copper usage in organic farming was 3,258 tons/year, which has been reduced to 52% of the permissible annual dose. Although this has not yet been placed on the agenda in our country, judging from development trends, reducing the use of copper formulations is a global imperative.

Europe has shown concern about the environmental impact of the copper components in Bordeaux mixture, especially the accumulation of copper ions in soil and its long-term environmental effects. Since copper ions can accumulate in living organisms, most European Union countries have banned the use of Bordeaux mixture, with only a few countries such as Belgium, Cyprus, France, Greece, Hungary, Italy, Malta, Portugal, Romania, and Slovenia still allowing its use.

Reducing the microparticle size of copper-containing formulations to thereby increase efficacy and reduce dosage is undoubtedly an effective approach to solving the global copper pollution problem. Over the past century, regarding Bordeaux mixture—a traditional, widely used pesticide variety with a protective role—people have not realized the issue that its microparticle size affects the control efficacy and increases the required dosage. With the improvement in understanding and innovative technological levels of pesticide formulations, the preparation of clear and transparent Bordeaux mixtures (with microparticle sizes down to sub-100 nm) at sprayable concentrations has been brought to the current agenda.

No literature on the preparation of nanoscale dispersions of Bordeaux mixture has been retrieved. Nanotechnology can be utilized to prepare copper formulations to improve the efficiency of Bordeaux mixture and reduce its environmental impact. Preparing nanoparticles generally involves shrinking copper or its compounds to the nanoscale; such particles may exhibit higher reactivity and better bioavailability due to their increased surface area, which can improve the environmental friendliness of Bordeaux mixture and enhance its antifungal efficacy.

In summary, Bordeaux mixture is an effective agricultural fungicide, but due to environmental considerations, its use is subject to certain restrictions. This makes it even more necessary to apply nanotechnology to improve its efficiency and reduce environmental impact, and the present invention aims exactly to explore the feasibility and effectiveness of these methods.

### PRIOR ART

1. “Preparation of Sodium Dodecyl Sulfate-Bordeaux Mixture Composites and Their Synergistic Antibacterial Performance” (Yu Zhuanni, Yu Liangmin, Wang Qiang, Modern Chemical Industry, 2014, 34(11): 91-94) This paper employs a traditional technique for preparing Bordeaux mixture, with the difference being that sodium dodecyl sulfate (SDS) is added to a copper sulfate solution and poured into Ca(OH)₂ in several batches. When 0.3 g/L of SDS is added, solid particles with a hollow thread-ball structure ranging from 3 to 5 μm in size are obtained, with a d(0.9) of 77.306 μm and a suspension rate of 90.1%. The differences between this technical solution and the present invention are: (1) The SDS used in that technology is a small molecule, a typical anionic surfactant containing sodium ions; whereas the present patent application uses alkyl ether ammonium sulfate, as well as complex additives formed together with non-ionic water-soluble polymers. The former possesses properties of both anionic and non-ionic surfactants due to the presence of a polyoxyethylene ether structure in its molecule. (2) The microparticle size of the Bordeaux mixture suspension concentrate prepared by that technology is a 3 to 5 μm hollow thread-ball structure, and d(0.9) is 77.306 μm. The Bordeaux mixture microparticle size prepared by the present patent application is a nano-suspension dispersion smaller than 100 nm.
2. “Study on the Preparation of Nano Basic Copper Sulfate Fungicide by Homogeneous Precipitation Method” (Yi Qiushi, Agrochemicals 2001, 40(8): 20-22) The method disclosed in this technology uses copper oxide as a raw material, reacting it with ammonia water and ammonium sulfate, distilling off ammonia under intense boiling conditions to obtain a solid product, and washing it with water and ethanol to obtain a solid basic copper sulfate. This technical solution differs drastically from the contents of the present patent application, including the reactants used, preparation methods and conditions, and product morphology. It describes the prepared “nanoparticulate basic copper sulfate,” but no particle size data is provided, and the particles aggregated in the electron micrograph have an unidentifiable scale bar. It also claims, “When the prepared nano basic copper sulfate is formulated at a content of 1-5% % in water containing a small amount of dispersant, it becomes highly dispersed into a near-translucent state.” Judging by the common knowledge of colloidal solutions, the particle size of microparticles in a “translucent state” should be in the hundreds of nanometers or close to a micrometer. Therefore, this technology cannot achieve nanoscale basic copper sulfate in a strict sense.
3. “Development of Nano Basic Copper Sulfate Suspension Concentrate and Study on Its Mechanism of Action” (Gao Mengmeng, Master's Thesis of Shenyang Agricultural University, 2021) This dissertation claims that using commercially available “nano basic copper sulfate” powder (particle size not specified), a 40% nano basic copper sulfate suspension liquid was prepared through the selection of several additives and grinding process conditions, but the prepared samples did not provide the particle size of the basic copper sulfate. The size data measured for the ground samples are as follows: D50(μm) is in the range of 2.09 to 2.87 μm. Particle size distribution: <5 μm, 98.2% to 91.21%; 5 to 15 μm, 8.7% to 9.6%; >15 μm, 0.23% to 1.2%. This indicates that the sizes of the basic copper sulfate prepared by this technology are mostly on the micrometer scale, far greater than 100 nm. Therefore, the technical solution published in this thesis cannot achieve nanoscale basic copper sulfate in a strict sense.

Given the current state of the art, where it is difficult to prepare nanoscale microparticles from basic copper sulfate solid technical materials, the present invention must find a new path to prepare a transparent Bordeaux mixture nano-suspension dispersion smaller than 100 nm. This also indicates that the target product prepared by the present invention involves significant technical difficulty.

### SUMMARY OF THE INVENTION

### Objectives of the Present Invention

One of the objectives of the present invention is to overcome the deficiencies of existing technologies and provide an innovative concept and technology distinct from existing Bordeaux mixture preparation techniques—the preparation of a transparent Bordeaux mixture nano-dispersion. Traditional Bordeaux mixture involves a reaction between copper sulfate and quicklime in water; quicklime is calcium oxide, which forms slaked lime (calcium hydroxide) in water, and calcium hydroxide reacts with copper sulfate to generate basic copper sulfate. Because the solubility of calcium hydroxide in water is relatively low, and the solubility of the product basic copper sulfate in water is even lower, the final obtained Bordeaux mixture is a light blue, viscous suspension with relatively large microparticle sizes. The innovative concept and technology of the present invention involve first dissolving one or several selected polymeric additives in water to formulate an aqueous solution. Then, copper sulfate, one of the raw materials for preparing Bordeaux mixture, and a pH buffer are dissolved in the aqueous solution of polymeric additives. Separately, one or several selected alkaline compounds are formulated into an aqueous solution. Under pre-stirring, by controlling conditions such as the addition method, speed, and stirring speed, a transparent Bordeaux mixture nano-suspension dispersion is ultimately obtained.

Another objective of the present invention is to reduce the microparticle size of the active ingredient (basic copper sulfate) of Bordeaux mixture. For convenience of use, commercially, factories first prepare solid basic copper sulfate technical materials and then process them into formulations. Since basic copper sulfate is insoluble in both water and organic solvents, current technologies rely on mechanical force for crushing and grinding, processing most of it into wettable powder formulations and a small amount into suspension concentrate formulations. Therefore, the microparticle sizes of commercially available Bordeaux mixture are all in the range of a few micrometers to tens of micrometers, which leads to an increased application amount. The transparent Bordeaux mixture prepared by the present invention has a microparticle size of less than 100 nm, massively reducing the microparticle size during application compared to traditional formulation products.

Yet another objective of the present invention is to shorten the processing workflow of Bordeaux mixture. The present invention integrates the synthesis process of traditional Bordeaux mixture (basic copper sulfate) and the formulation processing process into one; utilizing the water dilution process, it directly obtains a transparent Bordeaux mixture, eliminating the raw material synthesis and purification processes, as well as formulation processing steps, simplifying the entire operational procedure, dispensing with corresponding production equipment, and producing no wastewater in the process, thus improving production efficiency while being environmentally friendly and energy-saving.

A further objective of the present invention is to provide a highly efficient Bordeaux mixture nano-suspension dispersion that can be directly used for spraying operations. Because its microparticle size is greatly reduced, it can significantly increase the number of microparticles, improve efficacy, reduce dosage, and contribute to lowering the input of copper formulations into the ecological environment and reducing pollution.

### Innovative Concepts of the Present Invention

Research on nanopesticides targets pesticide varieties that are insoluble in water. The goal is to disperse them in water at their smallest aggregate size. The strategy usually adopted for preparing such pesticides is: dissolving the pesticide technical material in a certain solvent or complex solvent to form a monomolecular dispersion solution, and then preparing the solution into nanomicelles, nanocrystals, nanospheres, nanocapsules, nanogels, and various nanocarriers through different methods. However, for pesticide varieties that are “insoluble in both water and organic solvents,” given current technological levels, relying solely on mechanical crushing and grinding cannot reduce the pesticide microparticle size down to the nanoscale, let alone completely achieve a size below 100 nm.

The active ingredient of Bordeaux mixture is basic copper sulfate. It is a typical copper-containing inorganic compound with the property of being “insoluble in both water and organic solvents.” Therefore, preparing it into a transparent suspension dispersion with a microparticle size smaller than 100 nm is a difficult problem faced by the field of nanopesticide research, requiring the consideration of preparation methods different from conventional ones. The innovative concepts of the present invention are as follows:
Step One: Formulate water-soluble copper sulfate into an aqueous solution with a certain concentration. In its solution, copper sulfate molecules exist in a monomolecular dispersion state. On this basis, by selecting appropriate water-soluble polymeric surfactants (polymeric additives), they are co-dissolved in water to form a mixed solution of copper sulfate and water-soluble polymeric additives. To control the pH value, a buffer can be added, acting together as Component A.
Step Two: Select an alkaline compound that reacts with copper sulfate, and dissolve it in water to also form a monomolecularly dispersed alkaline solution, serving as Component B.
Step Three: Utilize the pesticide water dilution process by proportionally distributing the volume of dilution water for spraying operations, and dilute the above Component A and Component B into different proportions of water respectively.
Step Four: Under pre-stirring, by controlling different addition methods and speeds, as well as stirring methods and speeds, ensure that the generated basic copper sulfate microparticles are at the nanoscale, thereby obtaining a transparent Bordeaux mixture nano-suspension dispersion.

To achieve this goal, the following points must be considered:
Controlling the rate and number of crystal nuclei formed during the reaction to produce basic copper sulfate, as well as the growth rate of the crystals, is the key to obtaining microparticles smaller than 100 nm. This involves the selection of the type and dosage of the alkaline compound, the selection of the type and dosage of the water-soluble polymeric additives, as well as considerations regarding the control of pH changes in the system during the reaction and the stability of the dispersion after the nanocrystals are generated.
Alkaline Strength and Selection of Alkaline Compounds. The alkali used in traditional Bordeaux mixture is slaked lime, i.e., calcium hydroxide; its alkalinity is relatively weak, so its reaction rate with copper sulfate is slow and easy to control, but its water solubility is poor (solubility is about 0.165 grams/100 grams of water), forming large particles at high concentrations, making it difficult to separate from the generated even less water-soluble basic copper sulfate, ultimately resulting in the system forming a viscous suspension with large microparticle sizes. In addition to calcium hydroxide, alkaline compounds with greater solubility, such as sodium hydroxide, potassium hydroxide, and ammonium hydroxide, can also be used. The first two belong to strong alkalis and react rapidly with copper sulfate. Meanwhile, the alkalinity of ammonium hydroxide is relatively weak, and its reaction rate with copper sulfate is lower than the first two, resulting in a relatively slower rate of generating basic copper sulfate. Considering the control of the generation rate, microparticle nucleation, crystallization, and growth rates of basic copper sulfate, ammonium hydroxide should be selected as the reactant. If an appropriate increase in the reaction rate is desired, one could also consider combining ammonium hydroxide with one of the former two, adjusting the progress of this reaction process by selecting an appropriate mixing ratio.
Selection of the Type and Dosage of Water-Soluble Polymeric Additives. Copper sulfate reacts with alkaline compounds to produce basic copper sulfate; because the product is insoluble in water, molecular aggregation will inevitably occur in the water to form crystal nuclei, which continually bind with generated basic copper sulfate molecules, causing the crystals to keep growing until they eventually precipitate out of the water. The objective of the present invention is to control the crystal grain size of the generated basic copper sulfate to be no larger than 100 nm. To block the crystal nuclei generated in the water from further growing and to disperse, suspend, and stabilize them, water-soluble polymeric additives must be added to the system. Water-soluble polymeric additives possess hydrophilic groups, enabling them to dissolve in water and become colloidal solutions. The viscosity of a colloidal solution is much greater than that of small-molecule surfactants at the same concentration. The high viscosity of water-soluble polymer solutions is due to the morphological structure of water-soluble polymers in water being different from that of small molecules. Due to their large molecular weight and long molecular chains, polymers do not possess a straight-chain structure when dissolved in water but exist in a random coil morphological structure. These random coils are dispersed in water in a molecularly dissolved state, and their sizes range from a few nanometers to tens or even hundreds of nanometers, mainly depending on their relative molecular mass and molecular chain flexibility. These random coils exert a suspension effect on the nanocrystals generated in the solution; the principle lies in the loose spatial structure of the random coils, into which the very small basic copper sulfate crystal grains generated by the reaction will enter under stirring action, thereby providing functions such as dispersion, suspension, stabilization, and blocking crystal aggregation, ultimately preventing and controlling further growth of the crystal grains. Classifying water-soluble polymers by type, there are anionic, cationic, zwitterionic, and non-ionic types; categorizing by source, there are natural polymers and their derivatives, as well as synthetic polymers. The specific type and dosage of the water-soluble polymeric additive to select and use can be determined through experiments.
Selection of Dilution Water Volume. The amount of dilution water essentially determines the concentration of the generated copper sulfate nanoparticles in the system. Theoretically, the less dilution water used, the higher the concentration of copper sulfate nanocrystals, and the greater the tendency for mutual collision, crystal growth, and aggregation to occur, making the system less stable and more prone to the risk of precipitation. Conversely, with a large volume of dilution water, as long as the amount of polymeric additive is sufficient, it becomes easier to form a transparent and stable Bordeaux mixture nano-suspension dispersion.

### Terminology Explanation

Dispersion System: Dispersing one or more substances into another substance constitutes a dispersion system. The dispersed substance in a dispersion system is called the dispersed phase, and the other substance is called the dispersion medium. Based on the dispersed phase particle size, dispersion systems are divided into: Molecular (ionic) dispersion systems (particle size<1 nm); Colloidal dispersion systems (1 nm<particle size<100 nm).
Colloids and Sols: A colloid is a state in which matter exists at a certain degree of dispersion, rather than an inherent state of a specific type of matter. Many normally insoluble substances can be dispersed in a medium under appropriate conditions to form a seemingly uniform solution, which appears no different from a standard true solution on the outside, but belongs to the scope of colloidal matter in terms of diffusion speed, osmotic ability, etc., and is termed a Sol.
Classification of Colloidal Solutions: Based on the stability of colloidal solutions and the structure of colloidal particles, they are divided into: i) Lyophobic sols, abbreviated as Sols, formed by dispersing poorly soluble substances in a dispersion medium. The particles therein are composed of different numbers of molecules, possessing large phase interfaces and apparent free energy, and are highly unstable, easily destroyed and coagulated, cannot be restored to their original state, and are thermodynamically unstable and irreversible systems. ii) Macromolecular compound solutions, whose molecular size has reached the colloidal range and possesses colloidal characteristics, but are true solutions formed by molecules; they are thermodynamically stable, reversible systems, also known as Lyophilic sols.
System: A system refers to the system where an alkaline solution is added to a copper sulfate aqueous solution and reacts with the copper sulfate under the premise of controlling the addition method and speed, as well as stirring speed, when the present invention prepares a transparent Bordeaux mixture nano basic copper sulfate suspension dispersion. The system is composed of substances such as copper sulfate, alkaline compounds, polymeric additives, pH adjusters, and water.
Component: A component refers to a composition containing one or multiple constituents. In principle, any single constituent used in the present invention can individually form a component, but considering packaging, transportation, and convenience of use, the constituents should be combined and simplified. The principles are: i) The constituents do not react with each other; ii) The number of components formed by the constituents should not be too excessive.
Constituent: A constituent refers to the raw material substances used in the present invention, including water-soluble copper sulfate, sodium hydroxide, potassium hydroxide, ammonium hydroxide, water-soluble polymeric additives, buffers, and water.
Water-soluble Polymeric Additive: Refers to a macromolecular compound containing hydrophilic groups or hydrophobic backbones capable of dissolving in water, also known as a water-soluble polymeric surfactant or polymeric additive. Water-soluble polymeric additives can provide dispersing, suspending, emulsifying, and stabilizing functions. According to group properties, they can be divided into anionic, cationic, zwitterionic, and non-ionic polymeric additives.
Microparticle Size: Also known as microparticle dimension, refers to the size of the basic copper sulfate microparticles generated in the system; this microparticle is usually a crystalline grain, and does not specifically refer to the microscopic morphological structure of the grain.

Sub-100 Nanometer Level: Is a statistical classification of the pesticide microparticle size in the system. All microparticle sizes in the system exhibit a statistical distribution. The sub-100 nanometer level dispersion described in the present invention means that the size of at least 80% of the microparticles is less than this value. Microparticles larger than 100 nanometers account for only a small portion.
Ionic Strength: Ionic strength (I) is a measure of the effect of all ions in a solution on the electric field, which is related to the concentration and charge of the ions. The formula for calculating ionic strength is the following equation, where ci is the concentration of the i-th ion (in moles per liter), and zi is its charge number.

$$1. I = \frac{1}{2} \sum {c}_{i} {z}_{i}^{2}$$

Low Ionic Strength of Water: The ionic strength of water is very low. This is due to the low dissociation rate of pure water. For pure water, the concentrations of hydrogen ions (H⁺) and hydroxide ions (OH⁻) naturally produced by dissociation are extremely low (approximately 10⁻⁷ M). The dissociation degree of water is affected by various factors, including temperature, pressure, solvent properties, etc. At a pH of 7, the dissociation rate of water is 1.8×10⁻⁷%, which refers to the proportion of water molecules dissociating into hydrogen ions (H⁺) and hydroxide ions (OH⁻) under certain conditions.
Charge Shielding Effect: The charge shielding effect refers to the phenomenon where ions in a solution influence the distribution of surrounding ions through their charges, thereby reducing the interaction between ions. Under conditions of high ionic strength, ions in the solution will tend to distribute more evenly, reducing the charge impact in the solution, which may subsequently weaken the electrostatic repulsion between nanoparticles and increase the possibility of particle aggregation.
Effective Stirring Speed: The effective stirring speed refers to the stirring speed—not less than a certain effective threshold—applied when one component is added to another under a specific addition method, enabling the nanocrystals generated in the system to be promptly dispersed without undergoing crystal growth and aggregation into the hundreds of nanometers scale. The system product liquid exhibiting a transparent state is the hallmark of effective stirring.
Effective Stirring: The method and speed of adding components and stirring exert a significant impact on the system product liquid. Stirring methods include mechanical stirring, multi-point mechanical stirring, manual stirring, and multi-point manual stirring. Fast stirring speeds are conducive to producing favorable results. If the system product liquid presents a transparent state, it is considered effective stirring. Conversely, it is considered ineffective stirring.
Pre-stirring: When one component (the additive component) is added to another component (the base component), the relative contact speed of the two impacts whether the nanocrystals generated in the system can be dispersed promptly. Conducting pre-stirring prior to the addition of the additive component: that is, stirring the base component in advance so that its rotation reaches a certain speed, can yield a good dispersion effect. Generally, the rotational speed of pre-stirring should reach or approach the effective stirring speed.
Addition Method: The addition method encompasses the order in which different components are mixed with water, consolidating into two components. One of these two components is added into the other, or vice versa. Addition methods also include continuous addition, intermittent addition, fine-stream addition, dropwise addition, spray addition, as well as addition from a fixed position or a moving position. The optimal addition method is one that achieves mixing and dispersion as quickly as possible.
Addition Speed: After determining the addition method, control the addition amount of the components with the goal of achieving effective stirring.

### DETAILED DESCRIPTION OF INVENTION

1. Comparison of Reactions between Copper Sulfate and Alkalis (Sodium Hydroxide, Potassium Hydroxide, Ammonium Hydroxide) to Generate Basic Copper Sulfate Copper sulfate (CuSO₄) reacting with sodium hydroxide (NaOH), potassium hydroxide (KOH), or ammonium hydroxide (NH₄OH) can all produce basic copper sulfate. Considering the ease of implementation, the mildness of reaction conditions, and yield, the following two types of reactions are compared:
(1) Reaction with NaOH or KOH:

The reaction of CuSO₄ with NaOH or KOH is identical. They can generate either copper hydroxide or basic copper sulfate, depending on the molar ratio of the reactants. Taking potassium hydroxide as an example, the reaction formulas are respectively:

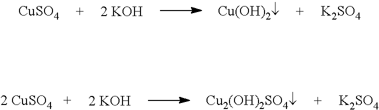

Looking at the two reaction equations, the key difference between generating copper hydroxide and basic copper sulfate lies mainly in the amount of alkali used. Two molecules of alkali reacting with one molecule of copper sulfate produces a copper hydroxide (Cu(OH)₂) precipitate. To form basic copper sulfate, the amount of alkali used must be controlled, i.e., reduced, so that it does not completely neutralize all copper ions in the copper sulfate, allowing a portion of the copper ions to precipitate in the form of basic copper sulfate. The ideal amount of alkali depends on the exact chemical formula of the basic copper sulfate desired, namely the ratio between copper sulfate and hydroxide.

Ease of realization and reaction conditions: Using NaOH or KOH to react with CuSO₄ to form basic copper sulfate is relatively easy to achieve because NaOH and KOH have high solubility in water and can quickly react with copper sulfate to produce copper hydroxide precipitate; the yield is relatively high, and basic copper sulfate formation can possibly be promoted by adjusting conditions (such as solution concentration and pH value). Considering the control over the formation speed of nanocrystals, a fast reaction speed is not an advantageous factor.

(2) Reaction with NH₄OH:

CuSO₄ reacting with NH₄OH can generate basic copper sulfate following a reaction formula similar to the potassium hydroxide mentioned above. For instance:

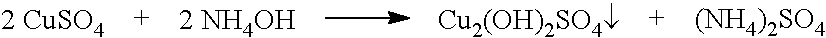

The precise chemical composition of basic copper sulfate might vary based on reaction conditions and the ratio of reactants. As another example, another reaction form is:

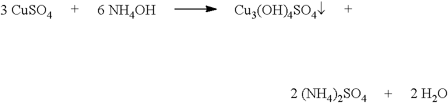

This reaction indicates that three molecules of copper sulfate react with six molecules of ammonium hydroxide to produce one molecule of basic copper sulfate, two molecules of ammonium sulfate, and water. This reaction formula is based on a specific form of basic copper sulfate, and the actual composition of the product may vary due to differing experimental conditions (such as reactant concentrations, solution pH, temperature, etc.).

Ease of realization and reaction conditions: Although using NH₄OH to react with CuSO₄ can also produce basic copper sulfate, this process might be somewhat more complex than the NaOH or KOH schemes, because ammonia water (NH₄OH) is a weak base in water, and its ability to react and produce basic copper sulfate is relatively weaker; the reaction conditions are mild, and a longer time is needed to complete the reaction, but it is advantageous for obtaining nanoscale basic copper sulfate.

### (3) Comparison of the Two Reactions

Chemical properties: NaOH and KOH are strong alkalis capable of reacting quickly and effectively with CuSO₄; whereas NH₄OH is a weak base, and its reaction rate is slower. For a reaction aiming to obtain solid precipitate of basic copper sulfate, the former undoubtedly holds an advantage, but for desiring to obtain a nanoscale basic copper sulfate suspension, a slower and gentler reaction is undoubtedly beneficial for control.

Reaction rate and yield: The rate and yield of the NaOH and KOH reactions are typically higher than those of the NH₄OH reaction, because strong alkalis are better at effectively promoting precipitate formation in a shorter time.

Operational simplicity: Due to the fast reaction speed and simple operation, using NaOH and KOH is generally easier to realize and obtain solid products, thus they are mostly applied in laboratory-scale preparations.

In summary, the NaOH or KOH scheme is typically more favored in laboratories for preparing basic copper sulfate solid products because these schemes possess advantages in reaction speed, operational simplicity, and yield. However, considering that the objective of the present invention is to prepare a basic copper sulfate nano-suspension dispersion, choosing the NH₄OH scheme, which features a slower reaction rate and mitigates precipitate formation, should be more suitable.

In certain circumstances, to further slow down the generation rate of basic copper sulfate crystal grains and prevent their rapid growth and aggregation, one can consider adding pH-adjusting substances into the system to lower the pH in localized regions formed when alkali (e.g., ammonia water) is added to the system. For instance, adding a salt of a strong acid and weak base, such as ammonium chloride or ammonium sulfate, can form a buffer solution with ammonia water.

### 2. Selection of Schemes for Preparing Nano Basic Copper Sulfate

The goal of the present invention is to prepare a transparent basic copper sulfate nano-dispersion, rather than aiming to quickly obtain high-yield solid precipitates of basic copper sulfate. Therefore, when selecting the most suitable scheme, it is essential to consider the reaction conditions, the controllability of reactants, and the dispersibility and stability of the final product. Although copper sulfate can react with sodium hydroxide (NaOH), potassium hydroxide (KOH), or ammonium hydroxide (NH₄OH) to produce basic copper sulfate, choosing a weak base offers an advantage for preparing stable nano-dispersions.

The reaction rate between copper sulfate and NH₄OH is slower, but this method may make it easier to control the growth rate of crystal grains and the generation of precipitates, facilitating the formation of nanoparticles with a more uniform size. In addition, ammonia water (NH₄OH) itself is an aqueous solution and does not need to be dissolved; adding a buffering agent that acts as a stabilizer can control the pH value, helping to stabilize the nanoparticles and prevent excessive growth of crystal grains.

In the preparation of nanoscale basic copper sulfate, the scheme using NH₄OH may provide more flexibility in controlling the particle size distribution, and the slower reaction rate is more conducive to the generation and stabilization of nanocrystals. Furthermore, selecting the optimal scheme requires considering nanoparticle stabilization techniques, such as selecting appropriate dispersants and surfactants, which is equally crucial for preventing particle aggregation.

Based on the difficulty of obtaining basic copper sulfate and the objective of preparing a transparent Bordeaux mixture with microparticle sizes less than 100 nm, and through the evaluation and comparison of the aforementioned schemes, the present invention chooses the reaction schemes of copper sulfate with sodium hydroxide, potassium hydroxide, or ammonium hydroxide, and preferentially selects the reaction scheme of copper sulfate with ammonium hydroxide.

Commercially, traditional production of basic copper sulfate aims to obtain high-purity solid technical materials for further processing into formulations. The transparent Bordeaux mixture prepared by the present invention is a nano-suspension dispersion that requires no purification and can be sprayed directly. The so-called “by-products” in the system, such as (NH₄)₂SO₄ and K₂SO₄, can both be used as nitrogen and potassium fertilizers needed for crop growth. This allows for the full utilization of resources.

### 3. Control of Reaction Conditions for Preparing Nano Basic Copper Sulfate

Preparing nanoscale basic copper sulfate is realized by allowing a copper sulfate solution and an alkaline solution (NaOH, KOH, NH₄OH) to react during mixing. The key lies in controlling reaction conditions, such as reactant concentration, reaction temperature, stirring speed, and the method of adding the alkaline solution. The reaction conditions that need to be considered for preparing nanoscale basic copper sulfate include:

Preparing solutions. Copper sulfate solution: first prepare a copper sulfate solution of a certain concentration. The concentration should not be too high to prevent the reaction from becoming too intense, which would make particle size difficult to control. Alkaline solution: select and prepare one solution from NaOH, KOH, or NH₄OH. The concentration of the alkaline solution should also be moderate; overly high concentrations could result in large product microparticles.

Controlling reaction conditions. Slow dropwise addition: under stirring conditions, slowly add the alkaline solution dropwise into the copper sulfate solution. Controlling the dropping rate is critical for particle size and uniform distribution. Stirring: ensure continuous and uniform stirring throughout the reaction process to promote a uniform reaction, avoiding high localized concentrations that lead to particle aggregation. Temperature control: the reaction can proceed at room temperature, or the temperature can be appropriately controlled (e.g., lowered) to optimize the formation and growth of nanoparticles.

Nanoparticle growth and stabilization. Polymeric surfactants: adding polymeric surfactants that serve dispersion and suspension functions before or during the reaction helps reduce particle size and prevent particle aggregation. pH adjustment: by finely adjusting the pH value of the solution (adding buffers), the generation rate, precipitation process, and product morphology of basic copper sulfate can be further controlled.

### 4. Control Method for Copper Sulfate Solution and Alkaline Solution Reacting to Generate Transparent Nano Basic Copper Sulfate Dispersion

To obtain a stable and transparent nano-suspension dispersion when copper sulfate solution reacts with alkaline solutions (NaOH, KOH, or NH₄OH) to generate nanoscale basic copper sulfate, reaction conditions must be controlled to facilitate the stable dispersion of nanoparticles in the solution, rather than forming macroscopic crystal precipitates. Furthermore, to maintain the transparency of the solution, the size of the nanoparticles needs to be extremely small, at least less than 100 nm, and highly dispersed. The following are methods to consider for controlling nanoparticle size:

Condition Control. If conditions permit, ultrasonic treatment can be used to help break up aggregated particles and promote the formation of smaller nanoparticles. Controlling reaction conditions by finely adjusting the addition rate of the alkaline solution, stirring speed, and reaction temperature can control the nucleation and growth processes of basic copper sulfate nanoparticles, thereby obtaining a smaller particle size.

Use of Appropriate Dispersants or Surfactants. The choice of dispersant is very important; adding an appropriate dispersant or surfactant can form a stable adsorption layer on the surface of the nanoparticles, preventing inter-particle aggregation, and helping to maintain the suspension stability of the nanoparticles in the solution. Therefore, selecting a dispersant compatible with basic copper sulfate is crucial.

Control of pH Value and Ionic Strength. Adjusting the pH value of the solution in the reaction area appropriately keeps it within a range conducive to the stable dispersion of nanoparticles and controls the formation speed. Adjusting the ionic strength in the solution minimizes the charge shielding effect that might lead to particle aggregation.

Dilution Effect. Appropriate dilution can lower the concentration of particles and the interaction forces between them, helping to maintain the transparency of the solution. This indicates that determining the dilution water volume is vital.

It should be noted that achieving the above objectives requires precise experimental design and condition optimization. Transparent nano solutions often require the particles to be extremely small and highly uniformly dispersed. Moreover, even if nanoscale dispersion is achieved, the concentration of the dispersion may still be influenced by the specific size and morphology of the nanoparticles, especially when the solution contains a high concentration of nanoparticles. Therefore, it is necessary to repeatedly adjust the type and concentration of the polymeric dispersant, reaction pH, and other conditions.

### 5. Selection of Polymeric Additives (Polymeric Dispersants)

Compatible with Basic Copper Sulfate When preparing a nanoscale basic copper sulfate dispersion, to prevent precipitation and maintain transparency, selecting appropriate water-soluble polymeric additives as dispersants is also key. These substances can help stabilize the nanoparticles, preventing their aggregation and precipitation, thus maintaining solution transparency. The water-soluble polymeric additives selected for the present invention include:
(1) Polyvinylpyrrolidone (PVP): PVP is a commonly used polymer dispersant that can effectively stabilize various nanoparticles and prevent their aggregation. PVP can form a stable protective layer by adsorbing onto the surface of nanoparticles.
(2) Polyvinyl alcohol (PVA): PVA is another common polymer dispersant, particularly suitable for aqueous systems. It can form a protective layer on the surface of nanoparticles, preventing inter-particle aggregation.
(3) Alkyl polyoxyethylene ether sulfates (sodium salts, ammonium salts): This is an anionic surfactant possessing non-ionic properties, widely used in the stabilization of nanoparticles. The lipophilic groups in the molecules can adsorb onto the surface of the nanoparticles, while the hydrophilic groups extend into the solution, enhancing particle dispersibility in water.
(4) Sodium carboxymethyl cellulose (CMC): CMC is a water-soluble starch derivative with anionic groups, which can act as an effective dispersant for stabilizing various nanomaterials. It improves dispersibility by adsorbing and forming a stable layer on the surface of nanoparticles.
(5) Polyoxyethylene ethers and their derivatives: These constitute a class of non-ionic surfactants where the polyoxyethylene ether is the hydrophilic group, and the lipophilic group can be an alkyl fatty chain, alkylaryl, alkylphenol, oleyl, polyoxypropylene, etc. It can form micelles and random coils with external hydrophilic groups and internal lipophilic groups, dispersing nanoparticles within.
(6) Amino silicone oil: Amino-modified silicone oil is a non-ionic surfactant that can be used for nanoparticle dispersion in organic solvents. For applications requiring the dispersion of nanoparticles in non-aqueous media, amino silicone oil is a good choice.
(7) Other anionic, non-ionic polymeric surfactants.

It must be noted that alkyl polyoxyethylene ether sulfates (sodium or ammonium salts) and sodium carboxymethyl cellulose are anionic surfactants possessing non-ionic performance, meaning their molecules contain parts that can dissociate negative charges in water. When these anionic surfactants encounter copper ions (Cu²⁺), they might form some kind of complexes. However, whether these possible products are water-soluble depends on specific conditions and reaction ratios. But if the concentration of such additives is high enough to provide sufficient water solubility through their hydrophilic groups, this complex might also retain a certain water solubility. Sodium carboxymethyl cellulose is a polymeric dispersant, and its interaction with copper ions may lead to copper ions coordinating along or between molecular chains; in this case, the water solubility of the complex largely depends on its molecular weight, degree of substitution, and other conditions in the solution. In certain situations, it can serve as a stabilizer to help copper ions remain dispersed in the aqueous solution.

In short, when using these polymeric additives as dispersants, it is critical to determine the most suitable concentration and conditions through experiments to achieve optimal dispersion effects and solution transparency. In addition, the selection of dispersants should also consider the property requirements of the final application area, such as whether they are biodegradable and their impact on the ecological environment. Hence, naturally biodegradable polymeric additives or their derivatives are the preferred types. Furthermore, in some cases, it may be necessary to combine different dispersants, creating composite additives, to achieve optimal results.

### 6. An Appropriate pH Range is Conducive to the Stable Dispersion of Nanoparticles

The stable dispersion state of nanoparticles in an aqueous solution is affected by various factors, including the pH value of the solution. The appropriate pH range depends on the specific nanoparticle type, surface properties, and the characteristics of the dispersant or surfactant used. Generally speaking, to enhance the stability of nanoparticles, the pH value should be adjusted to a range that maximizes the surface charge of the nanoparticles, which helps prevent nanoparticle aggregation through electrostatic repulsive forces.

Different types of nanoparticles have different pH ranges. For instance, Metal oxide nanoparticles (such as TiO₂, ZnO, etc.): the isoelectric point (IEP, meaning the pH value at which the particle surface charge is zero) of these particles usually dictates that for many common metal oxide nanoparticles, their stability is better under conditions where the pH is far from the IEP. For example, the IEP of TiO₂ is around pH 6.5, so nanoparticles are typically more stable in environments where pH<5 or pH>8. Silver nanoparticles (Ag):silver nanoparticles typically exhibit good stability in weakly acidic to neutral environments (pH around 5.5 to 7), because within this pH range, the surface can carry sufficient negative charge to promote electrostatic repulsion between particles. Organic nanoparticles (such as polymer nanoparticles): the stable pH range for this type of nanoparticles depends on the properties of the polymer. Generally, better stability can be achieved by maintaining the solution's pH within a range where the polymer does not degrade and under conditions that keep the nanoparticle surface charged.

For basic copper sulfate nanoparticles, the ideal pH range is likely from weakly acidic to weakly alkaline (approximately pH 6 to 7.5). Within this range, it is favorable for the stabilization of the nanoparticles. Substances added to maintain the system's stable pH value are called buffers. For basic substances like basic copper sulfate, the buffers should be strong acid-weak base salts, such as ammonium chloride, ammonium sulfate, etc.

It is worth noting that the appropriate pH range should also be determined experimentally, as nanoparticle stability is influenced not only by pH value but also by complex interactions under the presence of specific dispersants or surfactants, ionic strength, and temperature in the solution. Conducting a series of dispersibility tests to observe the stability and dispersibility of nanoparticles under different pH values can help determine the optimal pH range.

7. Influence of Ionic Strength on the Charge Shielding Effect that Leads to Particle Aggregation

Adjusting the ionic strength in a solution is a method to control the electrolyte concentration, aimed at influencing the interaction forces between charged particles in the solution. Ionic strength significantly impacts the charge shielding effect within a solution. The charge shielding effect refers to the phenomenon where ions in the solution influence the distribution of surrounding ions via their charges, thereby reducing interactions between ions. Under conditions of high ionic strength, the ions in the solution tend to distribute more evenly, reducing the charge impact within the solution, which may consequently weaken the electrostatic repulsion between nanoparticles, increasing the likelihood of particle aggregation.

Adjusting the ionic strength in a solution is usually achieved by adding non-reactive salts. These salts dissociate in the solution, releasing large amounts of ions, thus affecting the overall ionic strength. The operating methods are as follows: (1) Increase ionic strength. Adding an appropriate amount of an inert electrolyte (such as sodium chloride NaCl, potassium nitrate KNO₃, etc.) to the solution can increase the ionic strength. This practice is often used to reduce electrostatic repulsive forces between charged nanoparticles, helping particles move closer to each other. (2) Decrease ionic strength. Reducing the electrolyte concentration in the solution or using low ionic strength solvents can decrease ionic strength. This is typically achieved by diluting the solution or swapping solvents, helping to enhance the electrostatic interactions between charged particles, thereby preventing excessive aggregation.

In practical applications, appropriately adjusting the ionic strength requires comprehensively considering the characteristics of the nanoparticles, the desired dispersion stability, and final application objectives. For example, while excessively high ionic strength helps overcome electrostatic repulsion, it might also promote non-specific attractive forces like van der Waals forces, leading to nanoparticle aggregation.

The solvent used in the present invention is water. The ionic strength of water refers to half the sum of the product of the concentration of all ions in the solution and the square of their charge numbers. For pure water, the ionic strength is exceedingly low because the concentrations of hydrogen ions (H⁺) and hydroxide ions (OH⁻) naturally produced via dissociation in pure water are extremely low (around 10⁻⁷ M). However, in actual applications, water often contains various dissolved salts and minerals, all of which will increase the water's ionic strength.

Methods to reduce the ionic strength of water include: i) Deionization: Using deionized water or distilled water can significantly reduce water's ionic strength. Deionized water removes the vast majority of ions in water through ion exchange, reverse osmosis, or other water treatment technologies. ii) Ultrapure water: Utilizing an ultrapure water system (such as systems combining reverse osmosis and ion exchange) can yield water with extremely low ionic strength. Ultrapure water is widely applied in laboratories and high-tech industries; its ionic strength can approach zero. iii) Ion exchange: Using ion exchange resins can selectively remove specific ions from water, further reducing ionic strength. This method can specifically target the removal of cations or anions that cause the increase in ionic strength. The selection of which method to use for reducing the ionic strength of water often depends on application needs, cost considerations, and required water quality standards.

When preparing nanoscale basic copper sulfate solutions, the water's ionic strength needs to be low. Low ionic strength is advantageous in reducing the charge shielding effect within the solution, thereby enhancing the electrostatic repulsive forces on the surfaces of basic copper sulfate nanoparticles. This repulsive force helps prevent aggregation among the nanoparticles, keeping them in a stable dispersion state within the solution.

Low ionic strength water presents the following advantages: i) Enhanced electrostatic repulsion: In environments with low ionic strength, charges on the surfaces of nanoparticles undergo less shielding, leading to stronger electrostatic repulsion between particles, which helps prevent aggregation. ii) Improved stability: Low ionic strength helps maintain the dispersion stability of nanoparticles in the solution, reducing precipitation risks, thereby keeping the solution clear and transparent. iii) Controlled nucleation and growth: During the synthesis of nanoparticles, low ionic strength favors the precise control of nucleation and particle growth processes, aiding in the attainment of nanoparticles with a narrower size distribution.

Reducing the ionic strength of high-hardness water (i.e., water with high calcium and magnesium ion content) primarily aims to remove or reduce the multivalent metal ions such as calcium and magnesium within it. This not only reduces the hardness of the water but also helps decrease its overall ionic strength. Implemented treatment methods include: i) Ion exchange softening: using ion exchange resins to adsorb calcium (Ca²⁺) and magnesium (Mg²⁺) ions from the water. ii) Reverse Osmosis (RO) systems: utilizing semi-permeable membranes under a certain pressure to block dissolved solids in water, including hardness ions like calcium and magnesium, thereby removing them. iii) Chemical precipitation: adding chemical precipitants (like sodium carbonate) to water, causing calcium and magnesium ions to form water-insoluble precipitates, which are then removed through filtration. iv) Water quality stabilizers: adding water quality stabilizers that can form stable complexes with calcium and magnesium ions, thereby reducing the activity of these ions.

Water quality stabilizers primarily include: Polycarboxylates, such as polyacrylic acid (PAA), sodium polyacrylate (PAAS), polymaleic anhydride copolymers, etc. Phosphates and their derivatives, such as sodium hexametaphosphate (STPP), sodium pyrophosphate, etc. Chelating agents, ethylenediaminetetraacetic acid (EDTA), oxalic acid, citric acid, carboxymethyl chitosan, etc. Natural organic acids, such as citric acid, tartaric acid, etc.

### 8. Dilution Water Volume is Another Key Factor to Obtaining Nano Basic Copper Sulfate

To stabilize the transparent nano basic copper sulfate dispersion, aside from the effects of the aforementioned factors, the amount of dilution water is also a critical factor that needs to be controlled. High concentrations of basic copper sulfate are detrimental to the stable dispersion of nanoparticles; mutual collisions between particles lead to particle merging, growth, and eventually precipitation. Therefore, for a basic copper sulfate nanoparticle dispersion with a certain concentration prepared under specific conditions, there should be a certain correlation between the time frame during which solution transparency can remain stable and the volume of dilution water. This relationship must be confirmed via experiments.

The relationship obtained by the present invention between basic copper sulfate and the dilution water volume is: to obtain a transparent nano-suspension dispersion with 20 g of active ingredient basic copper sulfate, the dilution water volume per mu (Chinese unit of land area) is generally no less than 2 kilograms, i.e., the concentration of the transparent basic copper sulfate suspension should generally be less than 1%.

### Characteristics of the Transparent Bordeaux Mixture Nano-Suspension Dispersion

The transparent Bordeaux mixture nano-suspension dispersion is a nano-suspension dispersion in which basic copper sulfate microparticles are suspended and dispersed within a polymeric dispersant existing in a random coil morphological structure. The size of the basic copper sulfate microparticles is at the sub-100 nanometer level. The polymeric dispersant existing in a random coil morphological structure is compatible with basic copper sulfate. The polymeric dispersant existing in a random coil morphological structure is at least one of the following:
Polyvinylpyrrolidone;
Polyvinyl alcohol;
Alkyl polyoxyethylene ether sulfate;
Sodium carboxymethyl cellulose;
Polyoxyethylene ether and its derivatives;
Amino silicone oil. The transparent Bordeaux mixture nano-suspension dispersion uses pure water as a solvent. The pH range of the transparent Bordeaux mixture nano-suspension dispersion is weakly acidic to weakly alkaline. The numerical pH range for the transparent Bordeaux mixture nano-suspension dispersion is 5.5 to 8. The optimal numerical pH range is 6 to 7.5.

### Preparation Method of Transparent Bordeaux Mixture (Nano Basic Copper Sulfate)

The present invention adopts the following technical solutions: A preparation method for a transparent Bordeaux mixture nano-suspension dispersion, comprising the following steps:
1) Adding a copper sulfate aqueous solution into a polymeric dispersant aqueous solution, stirring and dispersing to form a transparent solution, obtaining a mixed solution of copper sulfate and polymeric additives, and adding a buffer to adjust the pH, referred to as Component A. Diluting according to the distribution ratio of dilution water volume to obtain a diluted solution of Component A.

The polymeric dispersant dissolved in the aqueous solution exists in a random coil morphological structure; the buffer adjusting the pH value is a salt of a strong acid and weak base such as ammonium chloride or ammonium sulfate.
2) Selecting an alkaline compound that reacts with copper sulfate, dissolving it in water to also form a monomolecularly dispersed alkaline solution, referred to as Component B. Diluting according to the distribution ratio of dilution water volume to obtain a diluted solution of Component B. The alkaline solution is an aqueous solution of sodium hydroxide, potassium hydroxide, or ammonium hydroxide, preferably an ammonium hydroxide aqueous solution.
3) The diluted Component A solution is first pre-stirred, and then the diluted Component B solution is added into the diluted Component A solution. Controlling addition speed and stirring speed enables uniform dispersion to obtain the transparent Bordeaux mixture nano-suspension dispersion.

To achieve a better stabilization effect, check the pH value of the transparent Bordeaux mixture nano-suspension dispersion in the system and adjust it to weakly acidic to alkaline.

The system is weakly acidic to alkaline, with a pH range of 6 to 7.5.

### 1. Preparation Of the Mixed Aqueous Solution of Water-Soluble Polymeric Additive and Copper Sulfate

Depending on the different components divided in the implementation schemes, such as a three-component scheme or a two-component scheme, specific implementation methods vary. The three-component scheme divides copper sulfate and water-soluble polymeric additives into Component A and Component C. For the two-component scheme, Component A can be considered equal to “Component A+Component C” from the three-component scheme. For the three-component scheme, the buffer to adjust pH can be added to Component A or Component C.

Taking the three-component scheme as an example, the preparation of the diluted dispersion is as follows:

According to the distribution ratio of the dilution water volume, first add the water-soluble polymeric additive or composite additive (Component C) into the allocated dilution water, stir to dissolve, and then add the copper sulfate aqueous solution containing the buffer to adjust pH (Component A), and stir to dissolve. This yields a mixed diluted aqueous solution of Component A and Component C, which contains the water-soluble polymeric additive, copper sulfate, and buffer.

### 2. Preparation of the Alkaline Aqueous Solution

Add the selected alkaline compound into the distributed proportion of dilution water, stir, and obtain the alkaline aqueous solution, referred to as Component B. In this process, one should note that the dissolution process of alkali in water is an exothermic process. To avoid concentrated heat generation, the alkaline compound should be added in small batches over multiple additions.

3. Reaction of Alkaline Aqueous Solution with Copper Sulfate Mixed Aqueous Solution

Under pre-stirring and an appropriate stirring speed, add the alkaline aqueous solution to the mixed diluted aqueous solution of copper sulfate, polymeric additives, and buffers, according to a specific addition method and speed.

Observe and keep the reaction system continuously displaying a transparent state until the alkaline aqueous solution has been fully added. Continue stirring, check the system pH, and adjust to 6 to 7.5 if necessary. The appearance of the system will be a transparent sky-blue solution, which is the transparent Bordeaux mixture nano dispersion. Shining a laser pointer through it shows a distinct light beam—the Tyndall effect. Observe the time it takes for precipitation to appear in the transparent dispersion; this time interval is the workable period for spraying operations.

### EMBODIMENTS

Example 1. Bordeaux mixture nano-suspension dispersion, usable for controlling downy mildew and bacterial angular leaf spot on cucumbers; a reported active ingredient dosage of Bordeaux mixture is 38 to 45 grams/mu. Considering the high efficiency of nanopesticides, the dosage of active ingredient of Bordeaux mixture in this example is 35 grams/mu. The dilution water volume is 50 kilograms.

According to the molecular ratio of the following chemical reaction equation:

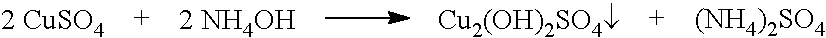

| | | |
|---|---|---|
| 320 | 70 | 257 |
| 44 | 9.5 | 35 |

The compositional dosages for each component, dilution water distribution ratios, and preparation methods for the solutions are listed in the following table:

| Compo- | | Mass | Total | |
|---|---|---|---|---|
| nent | Composition | (g/mu) | (g) | Preparation |
| A | Anhydrous copper | 44 | 400 | Add additives into |
| | sulfate | | | water, stir to dissolve, |
| | Ammonium sulfate | 40 | | add copper sulfate and |
| | Tween 80 | 40 | | ammonium sulfate, stir |
| | Alkylaryl | 40 | | to dissolve, obtain |
| | polyoxypropylene | | | Component A |
| | polyoxyethylene | | | aqueous solution |
| | ether | | | |
| | Sodium lauryl | 120 | | |
| | ether sulfate | | | |
| | Water | 116 | | |
| B | Ammonia water | 34 | 100 | Aqueous solution |
| | (28%) | | | |
| | Water | 66 | | |
| | Dilution water | | 50 kg | Dilution ratio for |
| | volume | | | Component A and |
| | | | | Component B: 9/10, |
| | | | | 1/10 |

### Operating Method:

(1) In a suitable container, add Component A to the water corresponding to the 9/10 distribution ratio (45 kg) and stir to dissolve, obtaining a diluted aqueous solution of Component A.
(2) In another suitable container, add Component B to the water corresponding to the 1/10 distribution ratio (5 kg) and stir to dissolve, obtaining a diluted aqueous solution of Component B.
(3) Under pre-stirring, add the diluted aqueous solution of Component B to the diluted aqueous solution of Component A using an intermittent spraying method. Control the addition speed and stirring speed to ensure uniform dispersion, pay attention to and keep the system constantly displaying a transparent state until Component B has been fully added.

Obtain the transparent Bordeaux mixture nano-suspension dispersion, directly usable for spraying operations. Stability time is 5 hours.

Example 2. Bordeaux mixture nano-suspension dispersion, usable for controlling citrus canker. One reported wettable powder formulation of Bordeaux mixture requires about 80 to 150 grams/mu of the Bordeaux mixture active ingredient. Considering the high efficiency of nano Bordeaux mixture, the dosage of active ingredient of Bordeaux mixture is 65 grams/mu. The dilution water volume is 150 kg/mu.

This example follows the molecular ratio of the following chemical reaction equation:

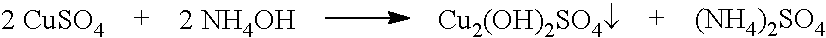

| | | |
|---|---|---|
| 320 | 70 | 257 |
| 81 | 18 | 65 |

The compositional dosages for each component, dilution water distribution ratios, and preparation methods for the solutions are listed in the following table:

| Component | Composition | Mass (g) | Total (g) | Preparation |
|---|---|---|---|---|
| A | Anhydrous | 81 | 81 | Solid material |
| | copper sulfate | | | |
| B | Ammonia water | 64 | 100 | Aqueous solution |
| | Water | 36 | | |
| C | Alkylaryl | 80 | 1000 | Disperse sodium carboxymethyl |
| | polyoxypropylene | | | cellulose in water, swell, stir to |
| | polyoxyethylene | | | dissolve, add other additives, |
| | ether | | | stir to dissolve, then add |
| | Castor oil | 100 | | ammonium chloride, stir to |
| | polyoxyethylene | | | dissolve, obtain Component C |
| | ether | | | |
| | Ammonium | 300 | | |
| | lauryl ether | | | |
| | sulfate | | | |
| | Sodium | 2 | | |
| | carboxymethyl | | | |
| | cellulose | | | |
| | Ammonium | 80 | | |
| | chloride | | | |
| | Water | 438 | | |
| | Dilution water | | 150 kg | Dilution ratio of “Component A + |
| | volume | | | Component C” and |
| | | | | Component B: 19/20, 1/20 |

### Operating Method:

(1) In a suitable container, add Component C to the water corresponding to the 19/20 distribution ratio (142.5 kg) and stir to dissolve, obtaining a transparent diluted aqueous solution of Component C.
(2) Add Component A to the diluted Component C solution, and stir to dissolve, obtaining a transparent mixed diluted aqueous solution of Component A and Component C.
(3) In another suitable container, add Component B to the water corresponding to the 1/20 distribution ratio (7.5 kg) and stir to dissolve, obtaining a transparent diluted aqueous solution of Component B.
(4) Under pre-stirring, add the diluted Component B solution via continuous spraying into the mixed diluted solution of Component A and Component C, controlling the addition speed and stirring speed, maintaining the system continually in a transparent state as the standard, until it is completely added.

Obtain the transparent Bordeaux mixture nano-suspension dispersion, directly usable for spraying operations. Stability time is 8 hours.

What is claimed is:

1. A transparent Bordeaux mixture nano-suspension dispersion, wherein the transparent Bordeaux mixture nano-suspension dispersion is a nano-suspension dispersion in which basic copper sulfate microparticles are suspended and dispersed in an aqueous solution of a polymeric dispersant existing in a random coil morphological structure.

2. The transparent Bordeaux mixture nano-suspension dispersion according to claim 1, wherein the size of the basic copper sulfate microparticles is at the sub-100 nanometer level.

3. The transparent Bordeaux mixture nano-suspension dispersion according to claim 1, wherein the polymeric dispersant existing in a random coil morphological structure is compatible with basic copper sulfate.

4. The transparent Bordeaux mixture nano-suspension dispersion according to claim 3, wherein the polymeric dispersant existing in a random coil morphological structure is selected from the group consisting of:
polyvinylpyrrolidone;
polyvinyl alcohol;
alkyl polyoxyethylene ether sulfate;
sodium carboxymethyl cellulose;
polyoxyethylene ether and its derivatives; and
amino silicone oil.

5. The transparent Bordeaux mixture nano-suspension dispersion according to claim 3, wherein the polymeric dispersant existing in a random coil morphological structure in water consists of at least two of the following:
polyvinylpyrrolidone;
polyvinyl alcohol;
alkyl polyoxyethylene ether sulfate;
sodium carboxymethyl cellulose;
polyoxyethylene ether and its derivatives;
amino silicone oil.

6. The transparent Bordeaux mixture nano-suspension dispersion according to claim 1, wherein the transparent Bordeaux mixture nano-suspension dispersion uses pure water as a solvent.

7. The transparent Bordeaux mixture nano-suspension dispersion according to claim 6, wherein the concentration of the transparent Bordeaux mixture nano-suspension dispersion is less than 1%.

8. The transparent Bordeaux mixture nano-suspension dispersion according to claim 6, wherein the pH range of the transparent Bordeaux mixture nano-suspension dispersion is weakly acidic to weakly alkaline.

9. The transparent Bordeaux mixture nano-suspension dispersion according to claim 8, wherein the pH range is 5.5 to 8.

10. The transparent Bordeaux mixture nano-suspension dispersion according to claim 8, wherein the pH range is 6 to 7.5.

11. A preparation method for a transparent Bordeaux mixture nano-suspension dispersion, comprising the following steps:
(i) adding an aqueous solution of copper sulfate to a pre-stirred aqueous solution of a polymeric dispersant, continuing to stir and disperse to form a transparent solution, obtaining a mixed solution of copper sulfate and polymeric additives, and adding a buffer to adjust the pH value, which is referred to as Component A; diluting according to the distribution ratio of the dilution water volume to obtain a diluted solution of Component A;
(ii) selecting an alkaline compound that reacts with copper sulfate, dissolving it in water to also form a single-molecule dispersed alkaline solution, which is referred to as Component B; diluting according to the distribution ratio of the dilution water volume to obtain a diluted solution of Component B;
(iii) pre-stirring the diluted solution of Component A first, and then adding the diluted solution of Component B to the diluted solution of Component A; controlling the addition speed and stirring speed to disperse evenly and obtain the transparent Bordeaux mixture nano-suspension dispersion.

12. The preparation method according to claim 11, further comprising the following step:
(iv) checking the pH value of the transparent Bordeaux mixture nano-suspension dispersion and adjusting it to weakly acidic to alkaline.

13. The preparation method according to claim 12, wherein the pH range is 6 to 7.5.

14. The preparation method according to claim 11, wherein the alkaline solution is an aqueous solution of sodium hydroxide, potassium hydroxide, or ammonium hydroxide.

15. The preparation method according to claim 11, wherein the polymeric dispersant is at least one of the following:
polyvinylpyrrolidone;
polyvinyl alcohol;
alkyl polyoxyethylene ether sulfate;
sodium carboxymethyl cellulose;
polyoxyethylene ether and its derivatives;
amino silicone oil.
